(19) United States
(12) Patent Application Publication
(10) Pub. No.: US 2026/0023056 A1
(43) Pub. Date: Jan. 22, 2026

(54) TEMPERATURE CONTROLLED OPTICAL SYSTEM FOR AN ABSORBANCE DETECTOR

(71) Applicant: Waters Technologies Corporation, Milford, MA (US)

(72) Inventors: Sebastien Besner, Bolton, MA (US); Iain Kanics, Acton, MA (US); Brett G. Cook, Lakeville, MA (US)

(21) Appl. No.: 19/273,950

(22) Filed: Jul. 18, 2025

Related U.S. Application Data
(60) Provisional application No. 63/673,396, filed on Jul. 19, 2024.

(51) Int. Cl. G01N 30/74; G01N 30/02; G01N 30/30

(52) U.S. Cl. CPC G01N 30/74; G01N 30/30; G01N 2030/027

(57) ABSTRACT

Described is an absorbance detector that can be used, for example, to detect analytes in a chromatography system flow. The absorbance detector includes separate temperature controlled zones that can be operated at different temperatures. A first temperature controlled zone includes a light source to provide light to probe a flow cell. A second temperature controlled zone includes the flow cell, a photodiode array and an optical system that is configured to direct light from the light source through the flow cell and to spectrally disperse the light across the photodiode array. The first and second temperature controlled zones may include a first housing and a second housing, respectively, to substantially enclose the components of their respective zones and to thermally isolate the zones from each other. A thermal isolator may be disposed between the temperature controlled zones to reduce heat transfer.

### RELATED APPLICATIONS

This application claims priority to U.S. provisional patent application No. 63/673,396 filed Jul. 19, 2025 and titled “Temperature Controlled Optical System for an Absorbance Detector,” the contents of which are incorporated by reference in their entirety.

### FIELD OF THE INVENTION

The disclosed technology generally relates to an absorbance detector for chromatography. More particularly, the disclosed technology relates to an absorbance detector having an optical system that includes an optical source temperature controlled zone and a separate optical bench temperature controlled zone. The two zones are thermally isolated from each other and the zone temperatures are independently controlled.

### BACKGROUND

Liquid chromatography systems are used to perform chemical separations. A typical liquid chromatography system consists of the following major components: a pump, an injector, a chromatography column, and a detector. The pump supplies a mobile phase, for example, a solution, through a fluid path comprising the injector, column and detector. The injector permits the introduction of samples into the mobile phase flow upstream from the column. The column contains a packed bed of media. The media is normally porous and relatively inert. Compounds in the sample exhibit a characteristic affinity to the media, that is, some compounds exhibit high affinity and some compounds exhibit low affinity. As a result, as the compounds are carried through the media, the compounds separate into bands which elute or come off the column at different times. These bands are detected by the detector.

Absorbance detectors are one exemplary type of detector that can be used to detect the bands eluting from the column. Broad spectrum or bandwidth limited light is directed through a flow cell passing the sample, and then measured at the chosen analytical wavelengths by a detector, such as a photodetector or photodiode array (PDA). In these instruments, light traverses a fixed distance (a path length) through the sample. Since the absorbtivity of an analyte typically varies according to wavelength, the instrument may include a spectrally dispersive optical element to spread the spectrum of the light across the PDA to obtain spectral information for the measurement. The compounds in the mobile phase flowing through the flow cell may be detected by the photodetector or PDA continuously over time.

The measured absorbance can change in response to a change in ambient temperature conditions. Additionally, thermally induced changes to the optical and mechanical components of the absorbance detector can modify the intensity of light sensed by the optical detector or PDA. For example, the expansion or contraction of components according to their coefficients of thermal expansion can alter the optical path of the light. Moreover, if the light from the spectrally dispersive optical elements is shifted in position on the PDA, spectral information for the measurements may be inaccurate. In addition, the intensity of the light emitted by the light source can change in response to a change in temperature of the light source and variations in the temperature of the mobile phase passing through the flow cell can induce variations in absorbance. Thus, temperature variations in the ambient environment that induce temperature changes in the absorbance detector components and mobile phase can degrade absorbance measurement accuracy and stability.

### SUMMARY

In one aspect, an absorbance detector comprises a first temperature controlled zone and a second temperature controlled zone. The first temperature controlled zone includes a light source and a first housing enclosing the light source. The second temperature controlled zone includes a flow cell, a photodiode array, an optical system and a second housing. The flow cell has a chamber configured to receive a sample and further configured to provide a light path through the sample. The optical system is configured to direct light from the light source through the flow cell to the photodiode array and includes a dispersive optical element to spectrally disperse the light from the flow cell across the photodiode array. The second housing encloses the flow cell, photodiode array and optical system and is configured to thermally isolate the second temperature controlled zone from the first temperature controlled zone and changes in ambient room temperature. The first and second temperature controlled zones are independently temperature controllable.

The absorbance detector may include a fan disposed in the second housing that is configured to generate an air flow through the second temperature controlled zone and a heater disposed in the air flow and being responsive to a control signal to thereby control a temperature of the second temperature controlled zone. The heater may be disposed proximate to an outlet of the fan. The flow cell, photodiode array and optical system may be disposed on an optical bench and the heater may be disposed on a side of the optical bench.

The absorbance detector may include a fan disposed proximate to the first housing that is configured to control an air flow inside the first housing to thereby control a temperature of the first temperature controlled zone.

The absorbance detector may further comprise a cover having internal fins that controls the air flow and homogenizes the heat generated by the heater to minimize a thermal gradient observed by the optical bench.

The absorbance detector may further comprise a plenum or enclosure to thermally isolate the optics bench from a rapid change in room ambient temperature and control an air flow comprising a combination of an intake, outtake, and internal flow around the optical bench.

The dispersive optical element may include a grating to spectrally disperse incident light.

The absorbance detector may include a thermal isolator disposed between the first and second temperature controlled zones.

The absorbance detector may include a first temperature sensor disposed in the first temperature controlled zone and a second temperature sensor disposed in the second temperature controlled zone.

The sample may include a flow of a mobile phase from a chromatography separation device.

The absorbance detector may further comprise a horizon filter configured to digitally control a target or setpoint temperature of at least one of the first and second temperature controlled zones, wherein the target or setpoint temperature is gradually adjusted in response to changes in ambient temperature over a time scale slower than a chromatographic separation cycle, thereby reducing power consumption and expanding the operating temperature range.

In another aspect, an absorbance detection system comprises a first temperature controlled zone comprising a light source and a first housing enclosing the light source; a second temperature controlled zone comprising a flow cell, a photodiode array, and an optical system configured to direct light from the light source through the flow cell to the photodiode array, the second temperature controlled zone enclosed by a second housing; a thermal isolator disposed between the first and second housings to reduce heat transfer between the zones; a first temperature control mechanism configured to maintain the light source at a first operating temperature; and a second temperature control mechanism configured to maintain the flow cell, photodiode array, and optical system at a second operating temperature, wherein the first and second temperature controlled zones are independently controllable and thermally isolated from each other and from ambient temperature variations.

The absorbance detector may further comprise a fan disposed in the second housing and configured to generate an air flow through the second temperature controlled zone; and a heater disposed in the air flow and being responsive to a control signal to thereby control a temperature of the second temperature controlled zone.

The absorbance detector may further comprise a fan disposed proximate to the first housing and configured to control an air flow inside the first housing to thereby control a temperature of the first temperature controlled zone.

The absorbance detector may further comprise a thermal isolator disposed between the first and second temperature controlled zones.

The absorbance detector may further comprise a first temperature sensor disposed in the first temperature controlled zone; and a second temperature sensor disposed in the second temperature controlled zone.

In another aspect, an absorbance detector, comprising: a first temperature controlled zone, comprising: a light source; and a first housing enclosing the light source; a second temperature controlled zone, comprising: an optical detection assembly; and a second housing enclosing the optical assembly and configured to thermally isolate the second temperature controlled zone from the first temperature controlled zone and from ambient room temperature; a fan disposed in the second housing and configured to generate an air flow through the second temperature controlled zone; and a heater disposed in the air flow and responsive to a control signal to regulate a temperature of the second temperature controlled zone, wherein the first and second temperature controlled zones are independently temperature controllable.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a schematic figure showing an example of an absorbance detector according to the principles described below.

FIG. 2A is a cross-sectional view through housings in an embodiment of an absorbance detector.

FIG. 2B is a top down semi-transparent view showing certain components inside the housings.

FIGS. 3A, 3B and 3C show a perspective view, a side view and a front view of the thermal isolator shown in FIG. 2A.

FIG. 4 shows a rack-mounted implementation of an absorbance detector that includes the components and features shown in FIGS. 2A and 2B.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

Various terminology is used in the description below. As used herein, a “spectrally dispersive optical element” means an optical component or device, such as a diffraction grating, that spatially disperses incident light according to the spectrum of the light. For example, the wavelength of the light determines the angle of propagation of the light from the element such that the spectrum of the light results in an angular spread of the light propagating from the element. A “flow cell” means a sample cell that can continuously conduct a fluid through the cell and permit light to pass through the liquid conducted through the cell while permitting continuous sensing of the light transmitted through liquid in the cell.

In brief overview, embodiments and examples disclosed herein are directed to an absorbance detector. The detector can be used, for example, to detect analytes from a sample injected into a chromatography system flow. The absorbance detector includes separate temperature controlled zones that are independently controllable. A first zone includes a light source to provide light to probe a flow cell downstream from a chromatography column or other separation device. A second temperature controlled zone includes the flow cell, a PDA and an optical system, some or all of which may be included in an optical detection assembly, that is configured to direct light from the light source through the flow cell and to spectrally disperse the light across the PDA. The first and second temperature controlled zones may include a first housing and a second housing, respectively, to enclose the components of their respective zones and to thermally isolate the zones from each other. A thermal isolator component may be disposed between the two temperature controlled zones (i.e., between the two housings) to reduce heat transfer between the zones.

During measurements, the light source within the first zone is maintained at a stable high temperature selected for optimal intensity performance while the system components within the second zone are maintained at a constant lower temperature (e.g., a few degrees C. above ambient temperature). Various performance advantages such as absorbance detector initialization time and measurement accuracy are achieved.

The light output of the light source's lamp can vary with the bulb temperature. Operating the lamp at a fixed temperature minimize the drift in the lamp output, which in turns minimize the absorbance baseline drift when no reference compensation is performed. Operating the lamp at a temperature within “optimal range” provided by the vendor minimize the peak to peak noise (lamp instabilities) and maximize the lamp lifetime. The change in the temperature of the optical bench, especially gradient in temperature, can change the overall transmission of the optical system and change the alignment of the spectrum on the PDA. Both can introduce an absorbance drift that can be minimized by keeping the temperature constant. Other advantages include faster warm-up time rather than initialization time.

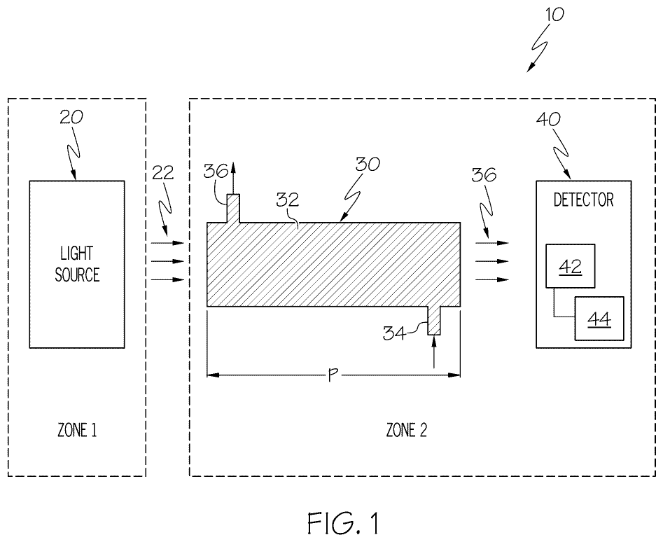

FIG. 1 is a highly schematic depiction of an example of an absorbance detector according to the principles described herein. The absorbance detector 10 includes a light source 20 that provides light into and through a flow cell 30. The light source 20 can be any light source capable of providing light of an appropriate spectrum and bandwidth, e.g., a deuterium, tungsten or xenon lamp. The light source 20 may also include various focusing lenses and reflectors.

The light 22 enters the flow cell 30 and passes through a sample in the sample chamber 32. The sample flows into the flow cell 30 through an inlet 34 and flows out of the flow cell 30 through an outlet 36. The light traverses a path length P through the flow cell 30 and is received and measured by a detector 40. The detector 40 can be any appropriate detector type, e.g., a silicon photodiode or a PDA. In the case of a PDA detector, the light 36 exiting the flow cell 30 is wavelength dispersed across the PDA. The light 36 that passes through the flow cell 30 is received by the detector 40, which produces an output signal indicative of the light as affected by the sample in the chamber 32. In various embodiments, the detector 40 is in communication with a processor and memory 44.

The light source 20 is disposed in a first temperature controlled zone (ZONE 1) and may include a lamp and a lamp housing. In some embodiments, the lamp housing may be exposed to the ambient environment while, in other embodiments, a thermal enclosure may substantially surround the lamp housing. Excessive temperature may decrease the operating lifetime of the lamp while operating below the recommended temperature range may result in lower optical intensity. Thus, the lamp housing may be equipped with fins to receive a cooling airflow from a fan.

In particular, the heat generated by the light source lamp would raise the temperature of the lamp, or more specifically, the lamp bulb, above its optimal operating when not properly cooled down. Generally, this temperature is much higher than the room temperature and the temperature of the lamp can be controlled by adjusting the cooling rate of the lamp housing by adjusting the fan speed. The heat generated by the lamp is large enough to accommodate “constant temperature” operating across our operating range simply by adjusting the amount of heat removed by the fan. Because of this, a simple fan rather than a fan in combination with a heater can be used.

The flow cell 30, detector 40 and intervening optical components (not shown) are disposed in a second temperature controlled zone (ZONE 2). The optical components may include a spectrally dispersive optical element, such as a diffraction grating, to angularly disperse the spectrum of the light from the light source. Each photodiode (or subgroup of photodiodes) in the PDA receives a respective portion of the spectrum. Thus, each photodiode can be used to determine received light in a corresponding region of the spectrum to allow for absorbance to be determined for various spectral ranges across the full spectral range. The spectral width of each spectral range is determined, in part, by the dispersive power of the spectrally dispersive element and the photodiode size and spacing in the PDA.

During operation, the light source may be maintained at a high temperature (e.g., 275° C.) for optimal output intensity while the flow cell, PDA and optical system may be independently controlled to be at a lower temperature (e.g., 35° C.). Advantageously, variations in measured absorbance due to variations in the ambiment temperature are substantially reduced. Another significant advantage resulting from independent temperature control of the two zones is that the lamp can reach its operating temperature quickly by disabling the lamp cooling fan upon lamp turn on. The cooling lamp can then be activated once the lamp housing temperature approaches or reaches a desired operating temperature. This reduction in system warm-up time provides a significant advantage over conventional systems in which system temperature control is not separated into independently temperature controlled zones. In such systems, the time required for the light source and the detector components to stabilize at proper operating temperatures can be excessive (several hours) and can therefore limit the useful operating time of the instrument. Although the lamp can instead be operated during periods when the instrument is not in use to reduce the wait time to initialize measurements, this is not a practical alternative as the extended on time of the lamp can consume a significant portion of its lifetime and require more frequent lamp replacement. In addition, the temperature of the optics bench can be kept constant regardless of whether or not the lamp is in an on or off state. The optics bench temperature is maintained by heat convection rather than conduction by thermally isolating conductive pathways between the heater and the bench. This can significantly reduce the warm-up time that is usually associated with higher noise and drift. Because the optics bench has a thermal mass much greater than the lamp or lamp housing, thermally isolating the bench from the lamp can significantly reduce the warm-up time.

The heater and fan controls may have restricted responsiveness. To overcome this, the system can't rely on sharp real-time adjustments. In some embodiments, a software-based horizon filter is implemented to monitor ambient temperature over time. In some embodiments, the horizon filter is applied to the optical bench zone, e.g., comprising flow cell, PDA, optics, and the like where fine-grained temperature control is critical to maintaining spectral accuracy. In doing so, the filter, applies a slow, deliberate drift in the system's thermal setpoint, or the temperature target for heaters and fans. This gradual adjustment enhances the effective dynamic range without violating hardware constraints—almost like simulating a finer control granularity through temporal smoothing. In particular, the filter can smooth the adjustment of temperature setpoints based on ambient trends, effectively expanding control capability without requiring more responsive hardware.

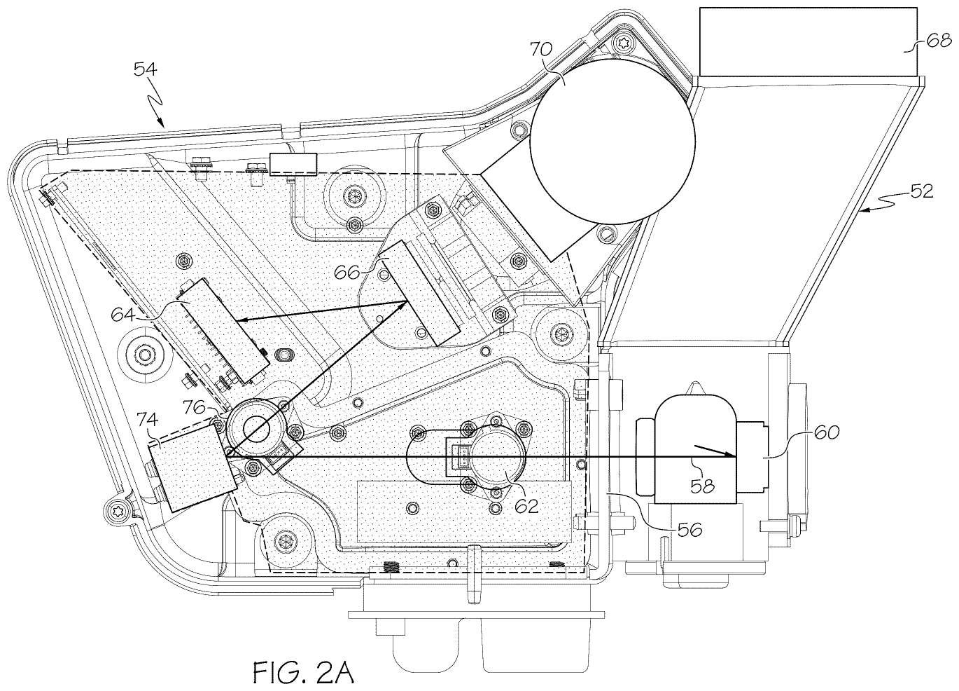

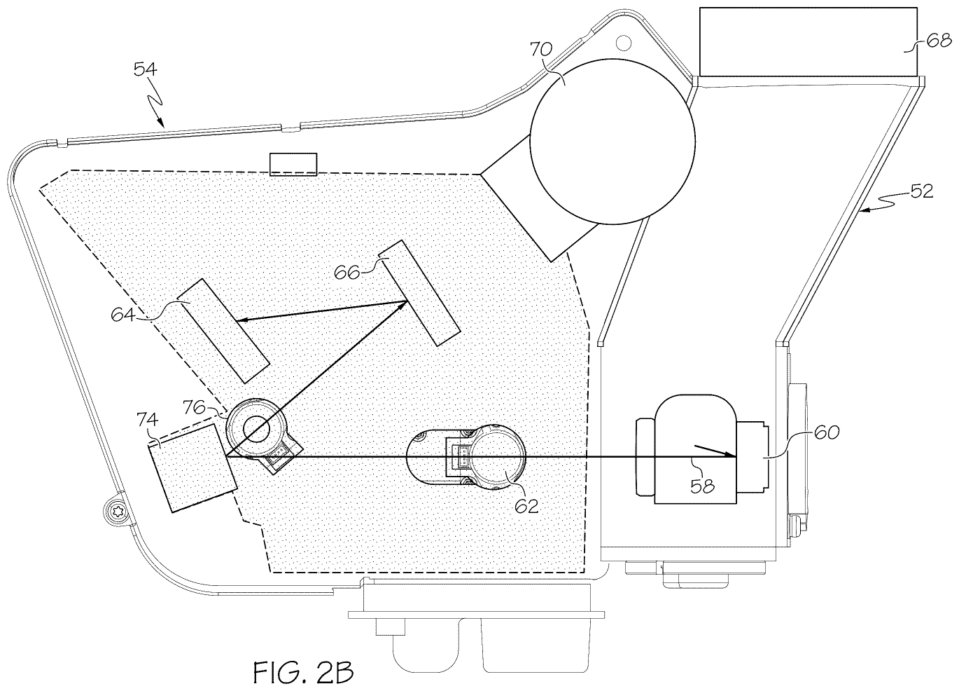

FIG. 2A and FIG. 2B are illustrations of one embodiment of an absorbance detector in accordance with the principles described herein. The absorbance detector includes a first housing 52 and a second housing 54 that define the first and second temperature controlled zones, respectively. FIG. 2A depicts a cross-sectional view through the housings 52 and 54 while FIG. 2B depicts a top down semi-transparent view with certain components depicted inside the housings 52 and 54. A thermal isolator 56 is secured to adjacent walls of the first and second housings 52 and 54 and has a low thermal conductivity such that heat transfer between the housings is substantially reduced.

The first housing 52 substantially surrounds a light source and a mirror 60 that redirects a portion of light emitted from the light source 58 into an optical system disposed on an optical bench inside the second housing 54. The second housing 54 substantially surrounds a flow cell 62, PDA 64 and other components of the optical system.

In operation, light from the light source 58 is received into the optical system and directed through the flow cell 62 to the PDA 64. A diffraction grating 66 spectrally disperses the light from the flow cell across the PDA 64. In alternative embodiments, the diffraction grating 66 may be replaced by other forms of spectrally dispersive optical elements. Other components on the optical bench include a turn mirror 74 and a variable slit 76.

The first housing 52 defines a volume that is partially occupied by the light source 58 and further includes a channel extending at one end from the light source volume to a cooling fan 68 at the other end. The light source 58 may be equipped with fins to receive a cooling airflow generated by the fan 68 which draws the heated air out from the housing 52. The fan 68 may be speed controlled as a means to control the temperature withing the lamp housing. In a non-limiting example, the lamp housing may be controlled to be approximately 10° C. to 15° C. above ambient temperature, for example, by modulating the speed of the fan 68. Light source intensity variations due to temperature changes are reduced by controlling the air temperature inside the housing to a substantially constant value.

The second housing 54 is defined by a plenum that contains an airflow circulation generated by a fan 70 such that the temperature variations in the environment enclosed by the housing 54 are substantially reduced. The second housing 54 may be implemented as a clamshell plastic plenum. The fan 70 may be disposed inside or along a wall of the second housing 54. As illustrated, the fan 70 draws a vertical flow of air into the housing 54 and the air flow is dispersed horizontally along the optical bench and components. In a preferred embodiment, one or more heaters are disposed in the air flow and respond to a control signal to control the temperature of the second temperature controlled zone. For example, one or more heaters can be disposed proximate to an outlet of the fan 70. The fan 70 effectively spreads the heat generated by the one or more heaters so that spatial temperature variations along the optical bench and elsewhere inside the second housing 70 are substantially reduced. In some embodiments, at least one heater is disposed on a side of the optical bench. . . . In some embodiments, the absorbance detector comprises a plenum or enclosure to thermally isolate the optics bench from a rapid change in room ambient temperature and control an air flow comprising a combination of an intake, outtake, and internal flow around the optical bench.

Each temperature controlled zone defined within a housing 52 or 54 may have one or more temperature sensors (e.g., thermocouples and/or thermistors) that are part of the respective temperature control system for the zone. For example, the temperature control system for the optical bench in the second housing 54 can rely on convection and enables the temperature of the one or more heaters to be controlled while operating the fan 70 at a constant speed to provide a flow of the heated air within the zone. Thus, thermal gradients within the zone are substantially reduced to thereby reduce temperature-induced misalignment of the optical components. In alternative embodiments, the rotational speed of the fan 70 may be modulated to achieve the desired temperature control. Preferably, the zone temperature is biased to be several degrees C. or more above the ambient temperature. A temperature sensor may be used to detect the ambient temperature so that any change in ambient temperature may result in a thermal response by the temperature control system.

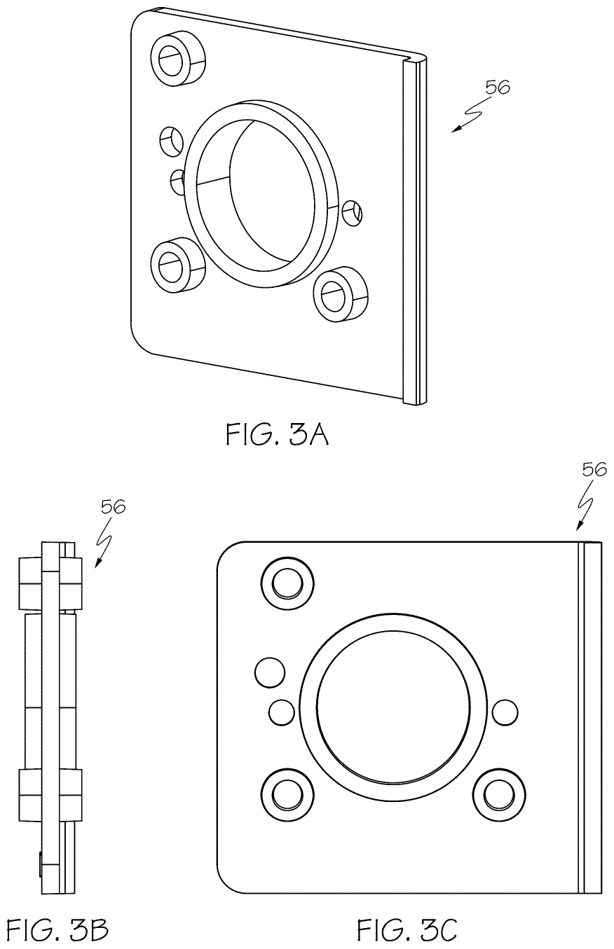

FIGS. 3A, 3B and 3C are a perspective view, side view and front view of the thermal isolator 56 of FIG. 2A. The isolator 56 includes openings 78 used to secure it between adjacent side walls of the first and second housings. A central aperture 80 enables light from the light source to pass from the first temperature controlled zone into the second temperature controlled zone where the optical system directs the light along an optical path through the flow cell to the diffraction grating and PDA. The thermal isolator 56 is formed of a low thermal conductivity material.

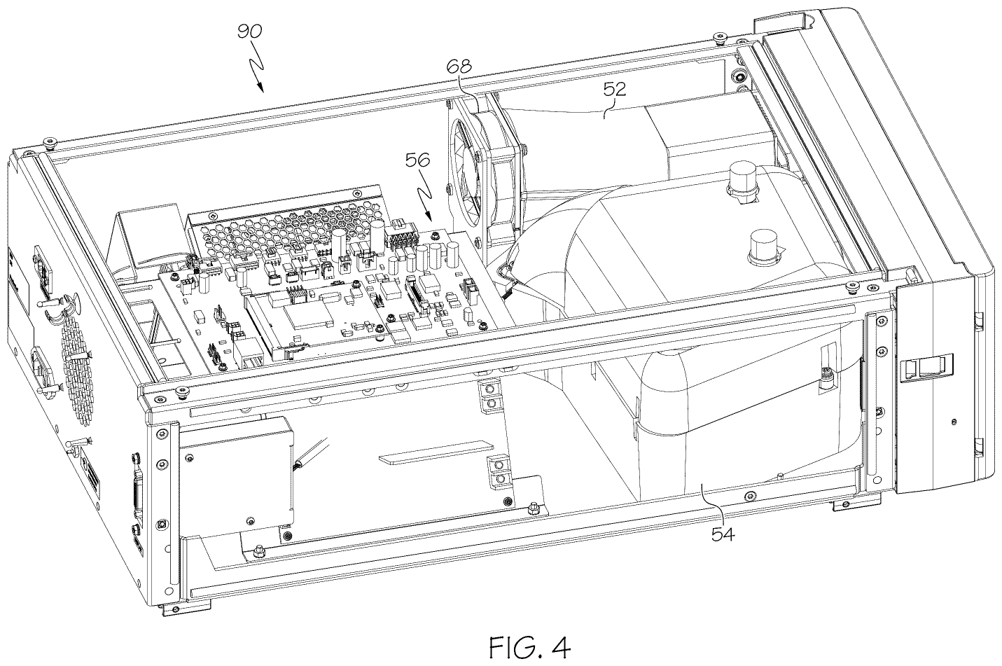

FIG. 4 shows a rack-mounted implementation of an absorbance detector 90 that includes the components and features shown in FIGS. 2A and 2B. It can readily be seen that the two housings 52 and 54 define distinct zones that are independently temperature controlled as described above. A circuit board assembly 56 includes electronic components used for data acquisition and thermal control of the independent zones, including components for receiving temperature sensor data or signals, generating control signals for the fans 68 and 70, and providing electrical power for the light source.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. An absorbance detector, comprising:
a first temperature controlled zone, comprising:
a light source; and
a first housing enclosing the light source; and
a second temperature controlled zone, comprising:
a flow cell having a chamber configured to receive a sample and further configured to provide a light path through the sample;
a photodiode array;
an optical system configured to direct light from the light source through the flow cell to the photodiode array, the optical system including a dispersive optical element to spectrally disperse the light from the flow cell across the photodiode array; and
a second housing enclosing the flow cell, photodiode array and optical system and configured to thermally isolate the second temperature controlled zone from the first temperature controlled zone and changes in ambient room temperature,
wherein the first and second temperature controlled zones are independently temperature controllable.

2. The absorbance detector of claim 1, further comprising:
a fan disposed in the second housing and configured to generate an air flow through the second temperature controlled zone; and
a heater disposed in the air flow and being responsive to a control signal to thereby control a temperature of the second temperature controlled zone.

3. The absorbance detector of claim 2, wherein the heater is disposed proximate to at an outlet of the fan.

4. The absorbance detector of claim 2, wherein the flow cell, photodiode array and optical system are disposed on an optical bench and wherein the heater is disposed on a side of the optical bench so that a temperature of the optical bench is maintained by heat convection by thermally isolating conductive pathways between the heater and the optical bench.

5. The absorbance detector of claim 4, further comprising a cover having internal fins that controls the air flow and homogenizes the heat generated by the heater to minimize a thermal gradient observed by the optical bench.

6. The absorbance detector of claim 4, further comprising a plenum or enclosure to thermally isolate the optics bench from a rapid change in room ambient temperature and control an air flow comprising a combination of an intake, outtake, and internal flow around the optical bench.

7. The absorbance detector of claim 1, further comprising a fan disposed proximate to the first housing and configured to control an air flow inside the first housing to thereby control a temperature of the first temperature controlled zone.

8. The absorbance detector of claim 1, wherein the dispersive optical element comprises a grating to spectrally disperse incident light.

9. The absorbance detector of claim 1, further comprising a thermal isolator disposed between the first and second temperature controlled zones.

10. The absorbance detector of claim 1, further comprising:
a first temperature sensor disposed in the first temperature controlled zone; and
a second temperature sensor disposed in the second temperature controlled zone.

11. The absorbance detector of claim 1, wherein the sample comprises a flow of a mobile phase from a chromatography separation device.

12. The absorbance detector of claim 1, further comprising a horizon filter configured to digitally control a target or setpoint temperature of at least one of the first and second temperature controlled zones, wherein the target or setpoint temperature is gradually adjusted in response to changes in ambient temperature over a time scale slower than a chromatographic separation cycle, thereby reducing power consumption and expanding the operating temperature range.

13. An absorbance detection system comprising:
a first temperature controlled zone comprising a light source and a first housing enclosing the light source;
a second temperature controlled zone comprising a flow cell, a photodiode array, and an optical system configured to direct light from the light source through the flow cell to the photodiode array, the second temperature controlled zone enclosed by a second housing;
a thermal isolator disposed between the first and second housings to reduce heat transfer between the zones;
a first temperature control mechanism configured to maintain the light source at a first operating temperature; and
a second temperature control mechanism configured to maintain the flow cell, photodiode array, and optical system at a second operating temperature,
wherein the first and second temperature controlled zones are independently controllable and thermally isolated from each other and from ambient temperature variations.

14. The absorbance detector of claim 13, further comprising:
a fan disposed in the second housing and configured to generate an air flow through the second temperature controlled zone; and
a heater disposed in the air flow and being responsive to a control signal to thereby control a temperature of the second temperature controlled zone.

15. The absorbance detector of claim 13, further comprising a fan disposed proximate to the first housing and configured to control an air flow inside the first housing to thereby control a temperature of the first temperature controlled zone.

16. The absorbance detector of claim 13, further comprising a thermal isolator disposed between the first and second temperature controlled zones.

17. The absorbance detector of claim 13, further comprising:
a first temperature sensor disposed in the first temperature controlled zone; and
a second temperature sensor disposed in the second temperature controlled zone.

18. An absorbance detector, comprising:
a first temperature controlled zone, comprising:
a light source; and
a first housing enclosing the light source;
a second temperature controlled zone, comprising:
an optical detection assembly; and
a second housing enclosing the optical assembly and configured to thermally isolate the second temperature controlled zone from the first temperature controlled zone and from ambient room temperature;
a fan disposed in the second housing and configured to generate an air flow through the second temperature controlled zone; and
a heater disposed in the air flow and responsive to a control signal to regulate a temperature of the second temperature controlled zone,
wherein the first and second temperature controlled zones are independently temperature controllable.

19. The absorbance detector of claim 18, further comprising a thermal isolator disposed between the first and second temperature controlled zones.

20. The absorbance detector of claim 18, further comprising:
a first temperature sensor disposed in the first temperature controlled zone; an
a second temperature sensor disposed in the second temperature controlled zone.
